(19) United States
(12) Patent Application Publication
(10) Pub. No.: US 2024/0201478 A1
(43) Pub. Date: Jun. 20, 2024

(54) MICROSCOPE

(71) Applicant: LEICA MICROSYSTEMS CMS GMBH, Wetzlar (DE)

(72) Inventor: Sebastian SIMMER, Wetzlar (DE)

(21) Appl. No.: 18/287,194

(22) PCT Filed: Feb. 24, 2022
(86) PCT No.: PCT/EP2022/054729

§ 371 Date: Oct. 17, 2023

(30) Foreign Application Priority Data
Apr. 23, 2021 (EP) 21170305.3

(51) Int. Cl. G02B 21/36; G02B 21/06; G02B 21/24

(52) U.S. Cl. CPC G02B 21/362; G02B 21/06; G02B 21/24

(57) ABSTRACT

A microscope for examining a sample includes a microscope stage for receiving the sample to be examined and further includes a microscope housing enclosing the microscope stage. The microscope housing includes a hinged door and an opening, the hinged door, in a closed state, covering the opening and including an inner surface and an outer surface, and, in an opened state, the inner surface or the outer surface becomes a top surface of an essentially horizontal work surface.

### CROSS REFERENCE TO RELATED APPLICATIONS

This application is a U.S. National Phase application under 35 U.S.C. § 371 of International Application No. PCT/EP2022/054729, filed on Feb. 24, 2022, and claims benefit to European Patent Application No. EP 21170305.3, filed on Apr. 23, 2021. The International Application was published in English on Oct. 27, 2022 as WO 2022/223181 A1 under PCT Article 21(2).

### FIELD

The present invention is directed to a microscope for examining a sample, the microscope comprising a microscope stage for receiving the sample to be examined and further comprising a microscope housing enclosing the microscope stage.

### BACKGROUND

In the field of microscopic examination of living samples like cells, it is common practice to make use of incubated sample chambers and/or to supply a reagent to the sample before or during examination of the sample. Such reagents comprise fluids, in particular liquids with or without chemically or biologically active substances, e.g. water, water-soluble or fat-soluble or other substances like hormones or medicine in a suitable carrier substance for triggering biological or chemical reactions with the sample or just for preserving the sample. Usually, the sample itself is located in multi-well-plates, Petri dishes or microfluidic systems on a microscope table. Pumps may be used for supplying the reagent to the sample. On the other hand, manual pipetting can be carried out.

Various kinds of containers, like Falcon tubes or Eppendorf tubes or Schott flasks, are used for storing the reagent. The containers are typically located outside the microscope housing, sometimes in a temperature controlled box. In many cases, only small amounts of a reagent need to be injected into a biological sample, especially in case of stimulants, like hormones or medicine drugs. On the other hand, larger amounts of reagent need to be exchanged for example in organ-on-a-chip experiments.

Additionally or alternatively, the sample is examined in an incubation atmosphere which provides best possible conditions to a living sample regarding temperature, humidity and gas composition. While access to the sample chamber is often needed for supplying a reagent to the sample, escape of incubation atmosphere should be limited.

Furthermore, in general, the sample handling, particularly the exchanging of samples, manipulating samples, supplying reagent to the sample etc., should be facilitated.

### SUMMARY

In an embodiment, the present disclosure provides a microscope for examining a sample, the microscope including a microscope stage for receiving the sample to be examined and further including a microscope housing enclosing the microscope stage. The microscope housing includes a hinged door and an opening, the hinged door, in a closed state, covering the opening and including an inner surface and an outer surface, and, in an opened state, the inner surface or the outer surface becomes a top surface of an essentially horizontal work surface.

In view of the above tasks in modern microscopy, especially for examining living samples, the inventors of the present invention have recognized there is a need for an improved microscope.

Embodiments of the present invention provide a microscope for microscopic examination of a sample, the microscope comprising a microscope stage for receiving the sample to be examined and further comprising a microscope housing enclosing the microscope stage, wherein the microscope housing comprises an opening closable by a hinged door which, in an opened state, is configured as a work surface and, in a closed state, forms at least a part of the microscope housing. Particular embodiments of the present invention provide a microscope for microscopic examination of a sample, the microscope comprising a microscope stage for receiving the sample to be examined and further comprising a microscope housing enclosing the microscope stage, wherein the microscope housing comprises a hinged door and an opening, the hinged door, in a closed state, covering the opening and comprising an inner surface (facing the inside of the microscope housing), also referred to as inner surface area, and an outer surface (facing the outside of the microscope housing), also referred to as outer surface area, and, in an opened state, the inner surface or the outer surface becomes a top surface, also referred to as top surface area, of an essentially horizontal work surface providing a workspace outside the interior space of the microscope housing which can be used by a user. “Essentially horizontal” covers a horizontal orientation and essentially horizontal orientations of the work surface such that objects and items placed on the work surface remain stably on the work surface without sliding or rolling down.

The hinged door may be configured such that the door can be pivoted down in the opened state such that the inner surface becomes a top surface of a horizontal or essentially horizontal work surface which also provides a storage area, a table or shelf. Such a workspace can be used for putting down things like reagent containers, laboratory bottles, pipettes, sample containers like multi-well-plates, Petri dishes and the like. Alternatively, the hinged door may be configured such that the door can be pivoted upward in the opened state such that the outer surface becomes a top surface of a horizontal or essentially horizontal work surface. At the same time, opening of the hinged door uncovers an opening in the microscope housing which provides, directly or indirectly, access to the microscope stage, i.e. to the sample chamber and/or to the sample itself. This opening can be dimensioned in a way to provide easy access to the microscope stage, on the one hand, and, on the other hand, especially in case of incubated sample chambers, to minimize disturbances of the sample inside the sample chamber and/or of the incubation atmosphere in the sample chamber. In its closed state, the hinged door forms at least a part of the microscope housing, such that the microscope housing preferably forms a closed entity.

The microscope according to embodiments of the present invention allows a user to inspect the sample and/or to manipulate the sample through the opening in the microscope housing, and, at the same time, to have a work surface/table/storage area integrated in the microscope housing.

In a preferred embodiment, in its opened state, the hinged door provides direct or indirect access to the microscope stage through the opening of the microscope housing. Basically, the opening in the microscope housing providing access to the microscope stage can either be directly closed by the hinged door or can be closed by a separate door (as will be explained in more detail below) which itself is covered by closing the hinged door. In the latter case, in the opened state, the hinged door provides access to the microscope stage through a second door arranged in the opening of the microscope housing. In the closed state of both the hinged door and the second door, the second door is arranged behind the hinged door. In a preferred embodiment, this second door is a sliding door and/or is at least partially transparent.

In this embodiment, opening the first hinged door provides access to the second door which, in its closed state, covers the opening of the microscope housing. The second door can be of a similar (or even the same) size as the first hinged door or, in a more preferred embodiment, can be of a smaller size, e.g. about 0.5, 0.4, 0.3, 0.25 or 0.2 of the size of the first hinged door. A smaller size of the second door ensures that disturbances of the sample and/or of the incubation atmosphere inside the sample chamber are minimized. In this case, the second door may be arranged in or at the opening of the microscope housing and may be integrated into a front panel of the microscope housing such that by closing the hinged door the front panel including the opening, which may be at least partly closed by the second door, is covered by the closed hinged door. A sliding door makes possible to uncover only a desired portion of the opening, which is needed for sample handling. An at least partially transparent second door makes it possible to monitor the sample inside the sample chamber on the microscope stage even if the opening is closed.

The embodiment of a first hinged door and a second door may also be called a “double-wall” solution. Still the hinged door, in the closed state, forms a part of the microscope housing and may be embodied as at least a part of a front cover of the microscope housing. The second door located behind the hinged door, as already indicated above, may be formed in a front panel of the housing serving for opening and closing the opening of the microscope housing, the opening being smaller than an opening defined by the hinged door itself. The “double-wall” embodiment will be further described below in connection with the Figures.

In a preferred embodiment, the hinged door is attached to a hinged lid of the microscope housing, which, when in an open state, provides direct access to the microscope stage. In this embodiment, the hinged lid carries the (closed) hinged door and can be hinged up or down or sideward to provide access to the microscope stage. In a preferred embodiment, the hinged lid is a part of the microscope housing. In the case of the “double-wall” embodiment, also the second door preferably forms a part of the hinged lid of the microscope housing. In this embodiment, by opening the hinged lid, the user opens a preferably bigger part of the microscope housing compared to an opening uncovered by opening the hinged door or the second door. Typically, the hinged lid is opened if a user needs a more spacious access to the interior of the microscope housing, for instance, to adjust optical components and/or the microscope stage. Also, this embodiment will be described in further detail below in connection with the figures.

In a preferred embodiment, the microscope further comprises a hinge mechanism and the hinged door is mounted to the hinged lid of the microscope housing by the hinge mechanism comprising at least one hinge. In a preferred embodiment, two hinges are used. Further, in a preferred embodiment, the hinge mechanism comprises a stop being configured to stop an opening movement of the hinged door. In a preferred embodiment, the opening movement of the hinged door is a hinge down movement such that the stop ensures that the hinged door is opened at an angle of 90° to provide a horizontal work surface.

Furthermore, in a preferred embodiment, the hinge mechanism includes a cable and a cable brake, the cable being mounted to the cable brake configured to damp an opening movement of the hinged door and/or to define an opening angle of the hinged door. The cable can be a steel cable or a cable made of fabric such as nylon. The cable may be biased to provide a resistance against an opening movement of the hinged door. It may also define an opening angle of the hinged door, which is preferably 90°.

In a preferred embodiment, the hinged door comprises a door locking mechanism configured to lock the hinged door in its closed state and to unlock the hinged door upon a user operation. The door locking mechanism—in a simple version—may comprise a magnet or a hook or snap lock. The hinged door, in its closed state, may be hold/locked by magnetic forces or by a latched hook. In order to open the hinged door, a user may simply open the hinged door by gripping the door itself or by manipulating a lever or button for unlocking the door locking mechanism.

In the “double-wall” embodiment described above, the opening of the microscope housing is formed in a front panel of the housing. In this case, it is preferred that the door locking mechanism is configured to lock the hinged door, in its closed state, with the front panel of the housing. In this case, the door locking mechanism, e.g. comprising a magnet, hook and/or snap lock, interacts with the front panel of the housing.

In an embodiment of the present invention, the microscope further comprises illumination optics for illuminating a sample to be examined, the door locking mechanism being operatively coupled to the illumination optics such that an illumination of the sample by the illumination optics can only be started when the hinged door is in the closed state and locked with the front panel. This embodiment is particularly advantageous in case the illumination optics comprises one or more lasers emitting laser light in order to protect a user from such laser light as long as the hinged door is in its opened state. In the latter case, the laser light is automatically switched off.

It is further advantageous if the microscope comprises an internal illumination of the interior of the housing or at least of a part of the housing forming the sample chamber, which internal illumination is configured to be automatically switched on when the hinged door is unlocked, or when the hinged door is opened. This enables a user to observe and better inspect the sample or the sample chamber directly or through the opened second door or even through the closed transparent second door.

In a preferred embodiment, where the hinged door is attached to a hinged lid of the microscope housing, as discussed above, the hinged lid comprises a lid interlocking mechanism and the hinged door comprises a separate door interlocking mechanism. The lid interlocking mechanism interacts with the door interlocking mechanism and keeps the hinged door in its closed state if the hinged lid is opened and as long as the hinged lid is in its open state. The lid interlocking mechanism is configured to allow opening of the hinged door only if the hinged lid is in a closed state. In other words, the door interlocking mechanism and the lid interlocking mechanism interact to avoid a simultaneous opening of both the hinged door and the hinged lid and thus ensures safety of operation.

Further advantages and embodiments of the invention will become apparent from the description and the appended figures.

It should be noted that the previously mentioned features and the features to be further described in the following are usable not only in the respectively indicated combination, but also in further combinations or taken alone, without departing from the scope of the present invention.

### BRIEF DESCRIPTION OF THE DRAWINGS

FIG. 1 schematically shows an embodiment of a microscope according to the present invention;

FIG. 2 schematically shows another embodiment of a microscope according to the present invention;

FIG. 3 shows an embodiment of a microscope according to the present invention having an opened hinged lid;

FIG. 4 shows the embodiment of FIG. 3 having a closed hinged lid;

FIG. 5 schematically shows, on a larger scale, an embodiment of a door locking mechanism, interlocking mechanisms, and a cable brake in a microscope according to the present invention; and

FIG. 6 shows a similar view as FIG. 3 showing a lid locking mechanism.

### DETAILED DESCRIPTION

In the following, the figures are described comprehensively, same reference signs designating same or at least structurally identical components.

Embodiments of the present invention are directed to a microscope for examining a sample, the microscope comprising a microscope stage for receiving the sample to be examined and further comprising a microscope housing enclosing the microscope stage. Such microscopes can particularly be used for examination of a sample located in a sample chamber, which is incubated with an incubation atmosphere adapted to the sample. In general, also other uses and applications of such a microscope can be envisaged.

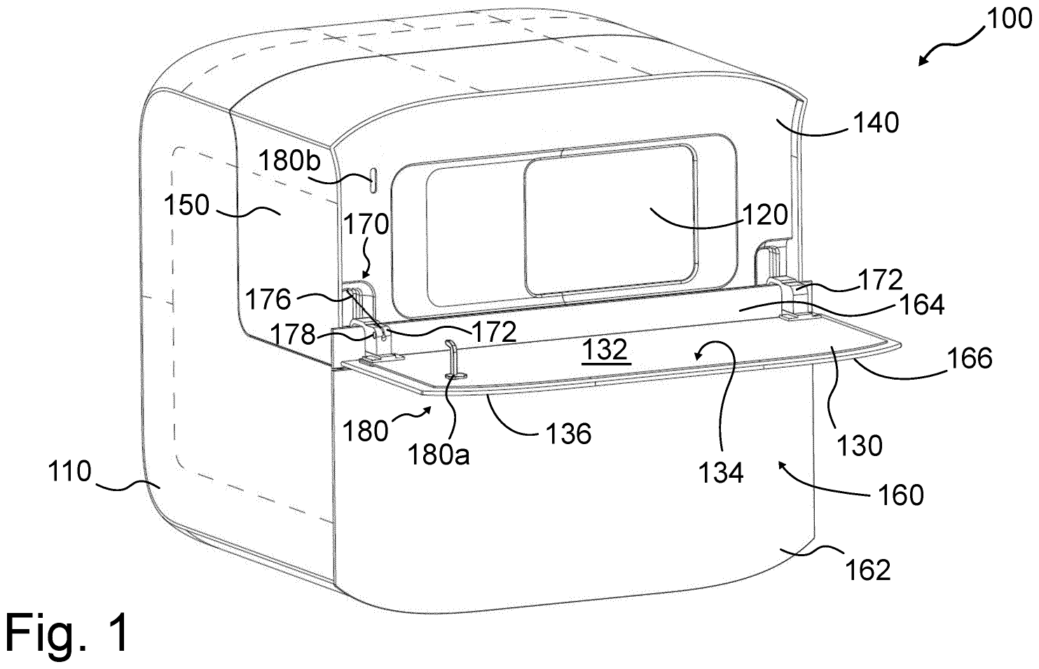

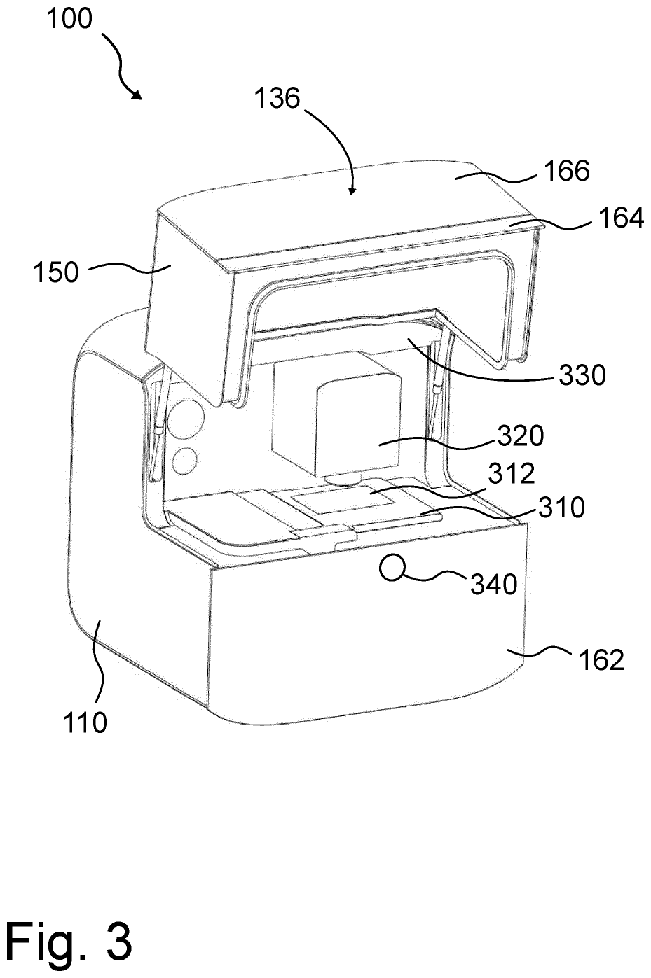

FIG. 1 schematically shows an embodiment of a microscope 100 for examining a sample, particularly a living sample like cells, the sample particularly being located in an incubated sample chamber. FIG. 1 schematically shows a microscope housing 110 which encloses a microscope stage for receiving the sample to be examined and further microscope components like illumination optics for illuminating the sample and imaging optics for imaging the sample (see also FIG. 3).

The microscope housing 110 comprises an opening 120 which is closable by a hinged door 130. While in the present embodiment, the size of the opening 120 is much smaller than the size of the hinged door 130, it is appreciated that the size of the opening 120 may be bigger and may even be comparable with the size of the hinged door 130. However, especially in case of an incubated sample chamber, it is preferred to have an opening size of around 0.25 or less of the size of the hinged door. As the opening 120 provides access to the sample chamber and the microscope stage, a small opening 120 ensures that disturbances of the sample itself and/or of the sample chamber incubation atmosphere can be minimized. For ease of illustration, no microscope components which may be visible through the opening 120 are depicted in FIG. 1. In this respect, reference is made to FIG. 3.

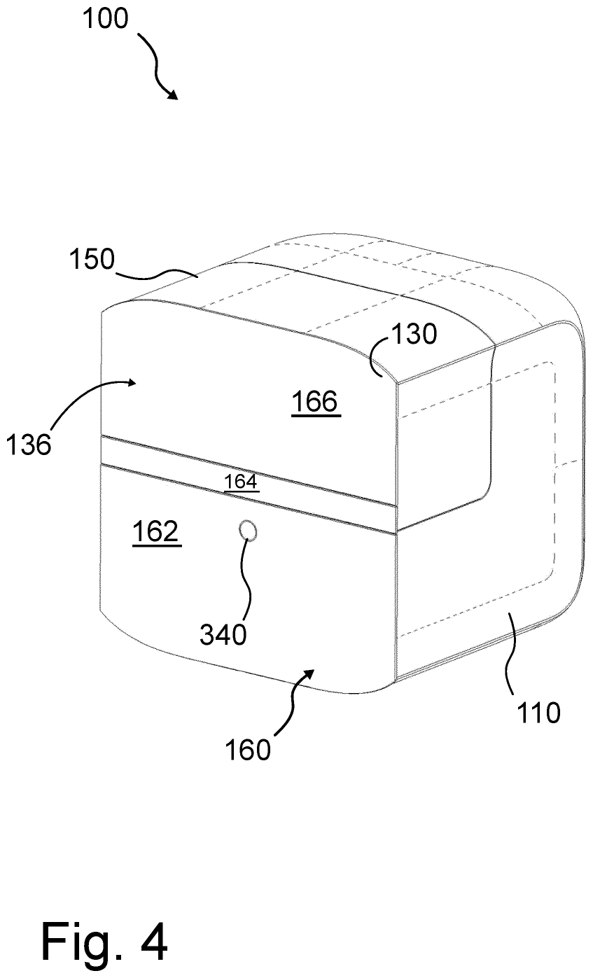

FIG. 1 shows the hinged door 130 in an opened state, which door is configured as a work surface 132. FIG. 4 shows the hinged door 130 in a closed state forming a part of the microscope housing 110, more precisely an outer surface or an outer surface area 136 of the hinged door 130 in a closed state becomes a part of the closed microscope housing.

In its opened state, the hinged door 130, more precisely an inner surface or an inner surface area 134 of the hinged door 130, is configured as a work surface providing a workspace outside of the interior space of the microscope housing, which can be used for putting down reagent containers, laboratory bottles, pipettes, sample containers like multi-well-plates, Petri dishes and the like. It is preferred that the hinged door in its open state withstands a minimum load of 500 g or 1 kg or 2 kg on the work surface 132 and a maximum load of about 5 or 4 kg, more preferred of about 3 or 2 kg. This concept allows a user to inspect the sample inside the microscope housing 110 and/or to manipulate the sample through the opening 120 while being able to use the work surface as a workspace/table/storage area without the need to use an external table or bench as the work surface 132 is integrated in or an integral part of the microscope housing 110.

As can be seen from FIG. 1, the opening 120 is formed in a front panel 140 of the housing 110. In such a construction, the hinged door 130 may form part of a front cover 160 of the microscope 100. FIG. 1 shows three different parts of the front cover 160, namely a lower front cover 162, a medium front cover 164, and an upper front cover 166. In its closed state, the hinged door 130 forms a part of the microscope housing by forming the upper front cover 166 as shown in FIG. 4.

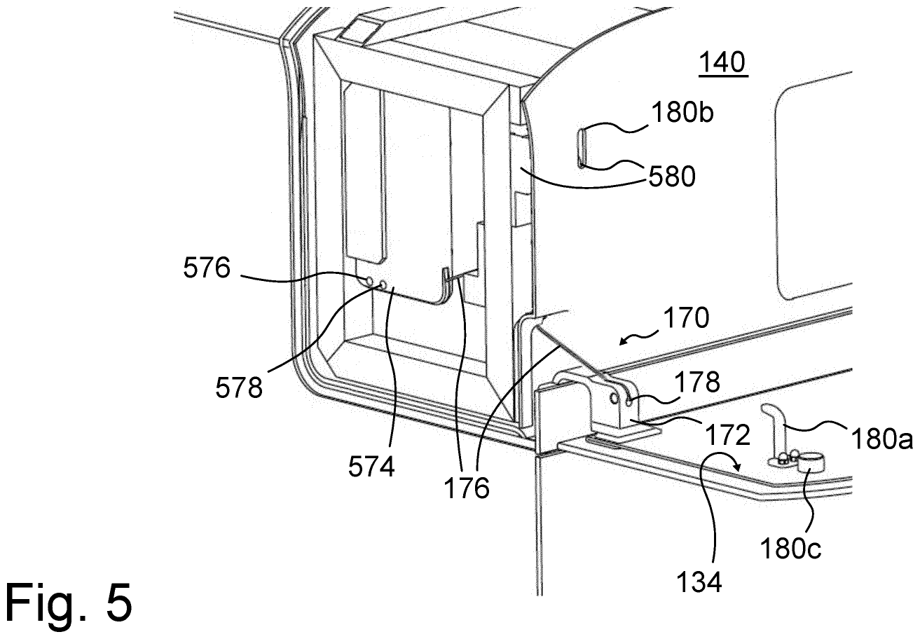

FIG. 1 also shows a hinged lid 150 which will be described in more detail in connection with the embodiment of FIG. 3. Further, FIG. 1 shows a hinge mechanism 170 for mounting the hinged door 130 to the microscope housing 110. The hinge mechanism 170 comprises at least one hinge 172, in the present embodiment two hinges 172. The hinge mechanism 170 further comprises a cable 176 mounted to a cable brake (see FIG. 5). As shown in FIG. 1, a cable 176 is connected by a cable holder 178 to one of the hinges 172. The cable brake which will be further described in connection with FIG. 5 serves the purpose of damping the opening movement of the hinged door 130 and/or to define an opening angle of the hinged door 130. As can be seen from FIG. 1, the opening angle should be essentially or exactly 90°.

The hinged door 130 further comprises a door locking mechanism 180 configured to lock the hinged door 130 in its closed state and to unlock the hinged door upon a user operation. To this end, a hook 180a is provided which engages with a corresponding opening 180b to lock the hinged door 130. Alternatively (or additionally) a magnet may be provided, which interacts with the front panel 140 to keep the door 130 in a closed state. An interlocking mechanism between the door and the lid will be described in further detail in connection with FIG. 5.

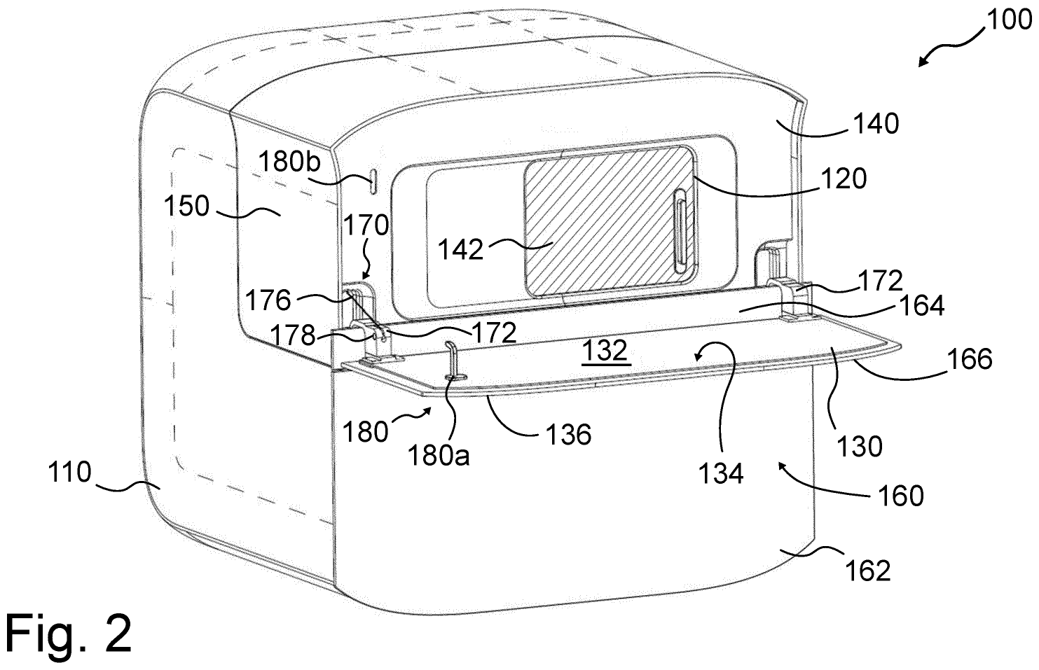

FIG. 2 schematically shows another embodiment of a microscope according to the present inventive concept, which is very similar to the one of FIG. 1. Therefore, in order to avoid repetitions, reference is made to the description of FIG. 1 and only the differences to the embodiment of FIG. 1 are described in the following.

As can be seen from FIG. 2, the opening 120 in the microscope housing 110 is covered by a second door 142 which is configured as a sliding door 142 such that the opening 120 can be uncovered by sliding the door 142 to the left. Having a second door 142 is especially useful when examining living cells in an incubated sample chamber. Loss of incubation atmosphere can be minimized. Only a part of the opening 120 can be opened, which is necessary to exchange a sample or to manipulate a sample inside the microscope housing 110. The second door 142 is preferably made of an at least partially transparent material such that a user can inspect the sample or the interior of the microscope housing 110 even if the door 142 is closed.

Regarding other features, options and components of the microscope 100 shown in FIG. 2, reference is made to the description of FIG. 1.

FIG. 3 schematically shows a microscope 100 according to the present inventive concept, embodiments of which having been discussed before, with an opened hinged lid 150. By opening the hinged lid 150, access to the interior of the microscope housing 110, in this embodiment to the upper part of the interior, is provided. Thus, a user can freely inspect or adjust any components inside the upper part of the microscope housing 110, which would otherwise be covered by the lid 150. In the embodiment shown, a user has access to e.g. an internal illumination 330, illumination optics 320, the microscope stage 310 and the sample 312. At the outside of the housing 110, at the front cover 162, a button 340 is provided for unlocking the hinged lid 150 before opening it.

As can be seen from FIG. 3, the microscope 100 is a transmitted-light microscope having imaging optics beneath the microscope stage 310 in a lower part of the microscope housing 110.

FIG. 4 schematically shows the microscope 100 of FIG. 3 with the hinged lid 150 in its closed state, its outer surface being denoted 136. As already indicated above, the front cover 160 of the microscope 100 comprises three parts 162, 164, 166. In its closed state, the microscope 100 resembles a cube. In this embodiment, the hinged door 130 can be opened by simply grabbing the hinged door 130 and pulling it in its opened state.

In the following, the door locking mechanism 180 and an interlocking mechanism 580 and the hinge mechanism 170 are explained in more detail in connection with FIG. 5.

The hinge mechanism 170 has already been described in connection with FIG. 1. FIG. 5 shows this mechanism in more detail. Cable 176 is clamped between the cable holder 178 and a cable brake 574. While the cable is fixed by cable holder 178 in the hinge 172, the cable brake 574 allows to damp the opening movement of the hinged door 130 and to adjust a corresponding resistance by adjustment screw 578 and to define an opening angle of the hinged door 130 by adjusting an opening angle adjustment screw 576.

In the embodiment shown in FIG. 5, the door locking mechanism 180 is configured as a door interlocking mechanism 180a, 180b for enabling an interlocking engagement with a lid interlocking mechanism 580. The hinged lid 150 comprises the lid interlocking mechanism 580 which interacts with the door interlocking mechanism 180a, 180b and keeps the hinged door 130 in its closed state if the hinged lid 150 is opened and as long as the hinged lid is in its open state. The lid interlocking mechanism 580 is configured to allow opening of the hinged door 130 only if the hinged lid 150 is in a closed state. In other words, the door interlocking mechanism 180a, 180b and the lid interlocking mechanism 580 interact to avoid a simultaneous opening of both the hinged door 130 and the hinged lid 150 and thus ensure safety of operation.

Additionally, the hinged door 130, at its inner surface 134, comprises a magnet 180c for holding the hinged door 130 in its closed state by magnetic forces to the front panel 140.

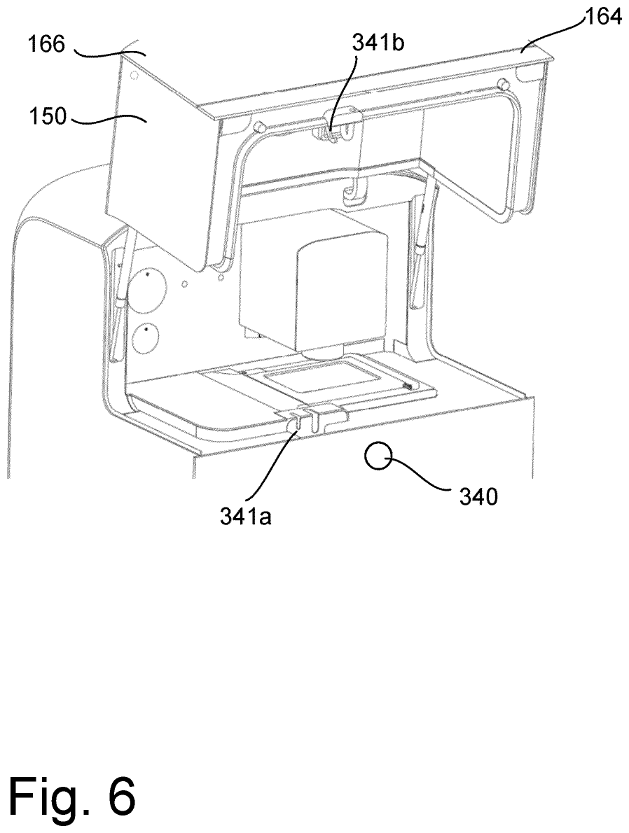

The lid interlocking mechanism 580 uses the hook 180a of the door interlocking mechanism 180a, 180b for locking the door 130 to the lid 150 as soon as the lid 150 is opened by operating the button 340 (see also FIG. 6).

On the other hand, if the hinged door 130 is opened, which is only possible if the hinged lid 150 is closed, hook 180a is disengaged from the lid interlocking mechanism 580 such that the corresponding switching element of the interlocking mechanism 580 is closed. This results in a blocking of the hinged lid 150. In this way, a simultaneous opening of the hinged door 130 and the hinged lid 150 can be avoided and safety of operation can be ensured.

FIG. 6 shows a similar view as FIG. 3 for illustrating the lid locking mechanism 341a, 341b in more detail. In a closed state of the lid 150, the locking parts 341a and 341b interlock with each other for locking the lid 150 in its closed state. By operating/pushing the button 340, the locking parts 341a and 341b are released and the hinged lid 150 can be opened.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 microscope
110 microscope housing
120 opening
130 hinged door
132 work surface
134 inner surface
136 outer surface
140 front panel
142 second door
150 hinged lid
160 front cover
162 lower front cover
164 medium front cover
166 upper front cover
170 hinge mechanism
172 hinge
176 cable
178 cable holder
180 door locking mechanism
180a hook, switching element
180b opening
180c magnet
310 microscope stage
312 sample
320 illumination optics
330 internal illumination
340 button
341a, 341b locking parts of lid locking mechanism
574 cable brake
576 opening angle adjustment
578 resistance adjustment
580 lid interlocking mechanism

1: A microscope for examining a sample, the microscope comprising a microscope stage for receiving the sample to be examined and further comprising a microscope housing enclosing the microscope stage,
wherein the microscope housing comprises a hinged door and an opening, the hinged door, in a closed state, covering the opening and comprising an inner surface and an outer surface, and, in an opened state, the inner surface or the outer surface becomes a top surface of an essentially horizontal work surface.

2: The microscope according to claim 1, wherein the hinged door, in the opened state, provides access to the microscope stage through the opening.

3: The microscope according to claim 1, wherein the microscope further comprises a second door arranged in or at the opening of the microscope housing and wherein the hinged door, in the opened state, provides access to the microscope stage through the second door.

4: The microscope according to claim 3, wherein the second door is a sliding door.

5: The microscope according to claim 1, wherein the hinged door is attached to a hinged lid of the microscope housing, which, in an opened state of the hinged lid, provides access to the microscope stage.

6: The microscope according to claim 5, wherein the microscope further comprises a second door arranged in or at the opening of the microscope housing and wherein the hinged door, in the opened state, provides access to the microscope stage through the second door, and wherein the opening including the second door forms a part of the hinged lid of the microscope housing.

7: The microscope according to claim 1, wherein the opening is formed in a front panel of the microscope housing.

8: The microscope according to claim 6, wherein the hinged door is mounted to the hinged lid of the microscope housing by a hinge mechanism comprising at least one hinge.

9: The microscope according to claim 8, wherein the hinge mechanism comprises a stop being configured to stop an opening movement of the hinged door.

10: The microscope according to claim 8, wherein the hinge mechanism includes a cable and a cable brake, the cable being mounted to the cable brake configured to damp an opening movement of the hinged door and/or to define an opening angle of the hinged door.

11: The microscope according to claim 1, wherein the hinged door comprises a door locking mechanism configured to lock the hinged door in its closed state and to unlock the hinged door upon a user operation.

12: The microscope according to claim 11 wherein the opening is formed in a front panel of the microscope housing, and wherein the door locking mechanism is configured to lock the hinged door, in its closed state, with the front panel.

13: The microscope according to claim 12, the microscope further comprising illumination optics for illuminating the sample to be examined, wherein the door locking mechanism is operatively coupled to the illumination optics such that an illumination of the sample by the illumination optics can only be started when the hinged door is in the closed state and locked with the front panel.

14: The microscope according to claim 11, the microscope further comprising an internal illumination of the interior of the microscope housing, which is configured to be automatically switched on when the hinged door is unlocked or opened.

15: The microscope according to claim 1, wherein the hinged door, in the closed state, is embodied as at least a part of a front cover of the microscope housing.

16: The microscope according to claim 5 wherein the hinged lid of the microscope housing comprises a lid interlocking mechanism, and a door locking mechanism is configured as a door interlocking mechanism, the lid interlocking mechanism and the door interlocking mechanism being configured to lock the hinged door in its closed state if the hinged lid is opened, and to allow an opening of the hinged door only if the hinged lid is in a closed state.
